(19) United States
(12) Patent Application Publication
(10) Pub. No.: US 2010/0291448 A1
(43) Pub. Date: Nov. 18, 2010

(54) FUEL CELL SYSTEM

(75) Inventors: Kenji Yamaga, Hitachi (JP); Katsunori Nishimura, Hitachiota (JP); Osamu Kubota, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/779,192

(22) Filed: May 13, 2010

(30) Foreign Application Priority Data
May 14, 2009 (JP) 2009-117443

(51) Int. Cl. H01M 8/04

(52) U.S. Cl. 429/429

(57) ABSTRACT

There is provided a fuel cell system capable of minimizing the formation of a local cell even if the start and the stop are repeated, thereby substantially reducing a degradation in performance of the fuel cell.

The fuel cell system includes a fuel cell; a hydrogen supply unit for supplying hydrogen to an anode channel of the fuel cell; an air-amount adjusting unit for adjusting the amount of air supplied to a cathode channel of the fuel cell and discharged from the cathode channel; an external load connected to the fuel cell; and a control unit for controlling an operation of the hydrogen supply unit, the air-amount adjusting unit, and the external load; in which the control unit controls the fuel cell system such that the cathode channel of the fuel cell is filled with air whose pressure is not higher than a saturated vapor pressure at the time of starting the fuel cell system, thereafter, the air is continuously led through the cathode channel of the fuel cell, and a load is drawn from the fuel cell.

### CLAIM OF PRIORITY

The present application claims priority from Japanese Patent application serial No. 2009-117443, filed on May 14, 2009, the content of which is hereby incorporated by reference into this application.

### BACKGROUND OF THE INVENTION

1. Field of the Invention

The present invention relates to a fuel cell system using an electric power generated by a fuel cell.

2. Description of Related Art

A fuel cell is an electrochemical device for directly converting the energy of a fuel into electric energy by an electrochemical reaction. The fuel cell is broadly classified according to a charge carrier to be used into a phosphoric acid fuel cell, a molten carbonate fuel cell, a solid oxide fuel cell, a polymer electrolyte fuel cell (hereinafter abbreviated as “PEFC”), and an alkaline fuel cell. The PEFC among these full cells is expected to be extensively applied, for example, to a stationary power supply and a backup power supply as well as a mobile power supply because the PEFC is capable of generating electricity at a high current density and operating at a comparatively low temperature.

FIG. 2 is an exploded perspective view showing the configuration of the PEFC. As shown in FIG. 2, the PEFC includes a membrane electrode assembly (hereinafter abbreviated as “MEA”) 33 on both sides of which electrodes are provided to center about a thin electrolyte membrane, a gas diffusion layer (hereinafter abbreviated as “GDL”) 32 provided on both sides of the MEA 33, and a separator 30 provided outside the gas diffusion layer 32.

Several tens μm to hundred and several tens μm thick proton exchange membrane is used as an electrolyte membrane for the MEA 33. In general, the ion exchange membrane has a structure in which a side chain with sulfonic acid group (sulfo group) is coupled with perfluorocarbon forming a main chain.

The electrode of the MEA 33 is formed by binding a platinum catalyst formed by dispersing platinum fine particles with several to several tens Å diameter on a surface of a carbon particle with several to several hundreds nm diameter as a carrier with a polymer having the same proton conductivity as the electrolyte membrane as a binder. The electrode is generally several μm to several tens μm in thickness. The reason why carbon is used as the carrier of the catalyst is that carbon is high in electron conductivity and chemical stability. Platinum is used in the micronized state to increase the surface area of the electrode and to increase the reaction rate of electrochemical reaction.

The GDL 32 is formed of a conductive porous material. The GDL 32 plays a role in quickly supplying fuel and oxidizer gas which are supplied from the GDL 32 and the separator 30 and contribute to electrochemical reaction to an active spot of the electrode being a reaction field and discharging the gas after the reaction with products. In general, the GDL 32 is made of a woven fabric or an unwoven fabric using a carbon fiber as a material.

The separator 30 includes an anode channel 36 and a cathode channel 37 supplying an anode gas (fuel gas) 34 and a cathode gas (oxidizer gas) 35 to the electrode through the GDL 32 respectively while separating both the gases supplied to unit cells adjacent to each other. The separator 30 is formed of a material having a high electric conductivity and a high corrosion resistance against a corrosive atmosphere in the cell because the separator 30 needs to cause electric current to flow into itself to capture the electric current produced by power generation. The separator 30 is formed of a carbon material or a metallic material subjected to an anti-corrosion process, for example.

The PEFC shown in FIG. 2 is a unit power-generation cell (unit cell). A fuel cell stack is formed by stacking a plurality of unit cells. Since the unit cell of the PEFC generates a voltage of 1 volt or less, the fuel cell stack formed by stacking the unit cells in series in order to increase the voltage is used. A fuel cell stack stacking several tens of unit cells is used as a home-use fuel cell system which has been developed. A fuel cell stack stacking several hundreds of unit cells is used for automobiles.

The PEFC operates at a comparatively low temperature as low as 70° C. to 90° C. For this reason, it is easier to start and stop the PEFC than other high-temperature fuel cells. A fuel cell for automobiles has been developed on the assumption that the number of starting and stopping the fuel cell is several thousands or more.

Component materials of a fuel cell are deteriorated with the start and the stop of the fuel cell system. For example, in a state where a cathode potential is reduced to lower the cell voltage and the system is stopped, oxidizer gas is supplied to the fuel cell to acquire electric power to produce a difference in potential between the upstream and the downstream of the cathode electrode surface. The difference in potential causes current to flow into the cathode electrode surface, and thereby a so-called local cell is formed. If a starting process forming the local cell is repeated, the carbon carrier of the cathode is gradually corroded and disappears, platinum fine particles on the surface of the carbon carrier aggregate together to decrease the surface area of the platinum fine particles, and thereby a problem of deterioration of cell characteristics occurs.

Patent Literature 1 (Japanese Patent Application Laid-Open No. 2007-287674), for example, discloses a fuel cell system restricting an upper limit of a cell voltage, an in-plane distribution of the cell voltage, and an increase rate of a unit-cell voltage at the time of supplying the oxidizer and minimizing the corrosion of an electrode material in order to solve the above problem.

### SUMMARY OF THE INVENTION

A conventional fuel cell system takes much time from start to the completion of start. Even if the cell voltage is controlled as described above at the time of supplying the oxidizer, the local cell is substantially formed to progress the deterioration of the fuel cell.

To solve the above problem, the present invention has its object to provide a fuel cell system capable of minimizing the formation of a local cell even if the start and the stop are repeated, thereby substantially minimizing a decrease in the performance of the cell.

To achieve the above problem, a fuel cell system according to the present invention includes a fuel cell; a hydrogen supply unit for supplying hydrogen to an anode channel of the fuel cell; an air-amount adjusting unit for adjusting the amount of air supplied to a cathode channel of the fuel cell and discharged from the cathode channel; an external load connected to the fuel cell; and a control unit for controlling an operation of the hydrogen supply unit, the air-amount adjusting unit, and the external load, in which the control unit controls the fuel cell system such that the cathode channel of the fuel cell is filled with air whose pressure is not higher than a saturated vapor pressure at the time of starting the fuel cell system, thereafter, the air is continuously led through the cathode channel of the fuel cell, and a load is drawn from the fuel cell.

### BRIEF DESCRIPTION OF THE DRAWINGS

FIG. 1 is a block diagram showing a configuration of an embodiment of a fuel cell system according to the present invention.

FIG. 2 is an exploded perspective view showing a configuration of the fuel cell in FIG. 1.

FIG. 3 is a flow chart showing a method for stopping the fuel cell system in FIG. 1.

FIG. 4 is a flow chart showing a method for starting the fuel cell system in FIG. 1.

FIG. 5 is a flowchart showing a first voltage reduction routine in FIG. 4.

FIG. 6 is a flowchart showing a second voltage reduction routine in FIG. 4.

FIG. 7 is a block diagram showing a configuration of a comparative example of a fuel cell system.

FIG. 8 is a flow chart showing a method for starting the fuel cell system in FIG. 7.

### DETAILED DESCRIPTION OF THE PREFERRED EMBODIMENTS

A preferred embodiment of the present invention is described below with reference to the accompanied drawings.

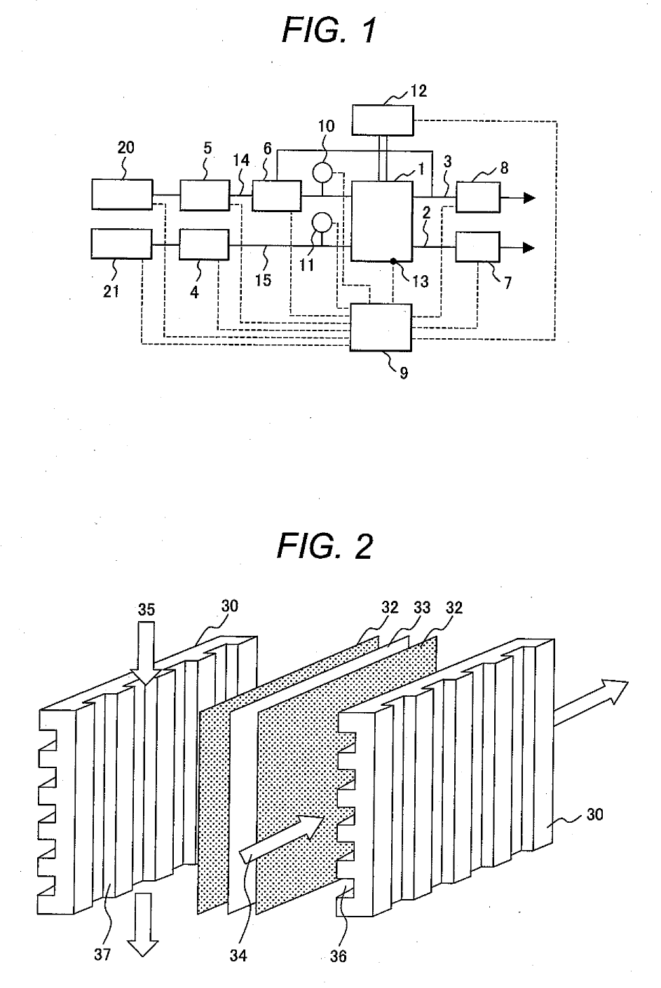

FIG. 1 is a block diagram showing a configuration of a fuel cell system according to the present embodiment. FIG. 2 is an exploded perspective view showing a configuration of the fuel cell 1 shown in FIG. 1.

As shown in FIG. 1, the fuel cell system includes a fuel cell 1, a hydrogen supply source 20 for supplying the fuel cell 1 with hydrogen, an air blower 21 for supplying the fuel cell 1 with air, and a control unit 9 for controlling the start and the stop of the fuel cell system. The fuel cell 1 is a fuel cell stack in which a plurality of unit fuel cells are stacked (refer to FIG. 2). As shown in FIG. 2, the unit fuel cell is formed such that a gas diffusion layers (GDL) 32 are provided on both sides of a membrane electrode assembly (MEA) 33 into which an electrode and an electrolyte membrane are integrated and the separators 30 are provided outside the GDLs 32. An anode channel 36 into which an anode gas (fuel gas, hydrogen gas) 34 is caused to flow is formed in a surface of a separator 30 opposing an anode gas diffusion layer. A cathode channel 37 into which a cathode gas (oxidizer gas, air) 35 is caused to flow is formed in the surface of the separator 30 opposing a cathode gas diffusion layer. The details of the unit fuel cell are similar to the above general one.

In FIG. 1, the hydrogen supply source 20 supplies hydrogen to the anode channel 36 of the fuel cell 1 through a hydrogen supply line 14. The hydrogen supply line 14 is provided with an anode pressure regulation valve 5 for regulating the supply of hydrogen. An anode pressure sensor 10 for measuring the pressure of hydrogen is provided at a downstream position of the anode pressure regulation valve 5. The air blower 21 supplies air to the fuel cell 1 through an air supply line 15. The air supply line 15 is provided with a cathode pressure regulation valve 4 for regulating the supply of air. A cathode pressure sensor 11 for measuring the pressure of the cathode is provided at a downstream position of the cathode pressure regulation valve 4.

An outlet of the anode channel 36 of the fuel cell 1 is connected to a hydrogen discharge line 3 for discharging hydrogen. The hydrogen discharge line 3 is provided with a hydrogen outlet valve (anode outlet valve) 8. An outlet of the cathode channel 37 of the fuel cell 1 is connected to an air discharge line 2 for discharging air. The air discharge line 2 is provided with an air outlet valve (cathode outlet valve) 7. The hydrogen supply line 14 is provided with a hydrogen circulation system 6 for re-circulating unused hydrogen from the hydrogen discharge line 3. The fuel cell 1 is further provided with a voltage sensor 13 for measuring an average cell voltage of the fuel cell stack. A power collection terminal of the fuel cell 1 is connected to an external load 12 for delivering electric power generated in the fuel cell 1 to the outside.

Pressure and voltage measured by the anode pressure sensor 10, the cathode pressure sensor 11, and the voltage sensor 13 are input to the control unit 9. The control unit 9 controls the drive of the hydrogen supply source 20, the anode pressure regulation valve 5, the air blower 21, the cathode pressure regulation valve 4, the hydrogen outlet valve 8, the air outlet valve 7, the anode circulation system 6 (these are collectively referred to as auxiliary equipments), and the external load 12. The control unit 9 controls the drive of the auxiliary equipments to switch among an external load start mode in which the voltage generated by the fuel cell 1 is started to be supplied to the external load 12; a power generation mode in which the voltage generated by the fuel cell 1 is constantly supplied to the external load 12; and an external load stop mode in which the voltage of the fuel cell 1 is reduced to decrease the supply of voltage to the external load 12.

A method for stopping the fuel cell system is described below.

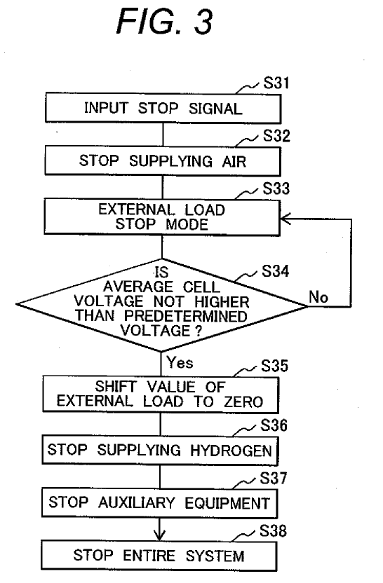

FIG. 3 is a flow chart showing a method for stopping the fuel cell system.

As shown in FIG. 3, in step S31, instructions for stop are input. In step S32, the supply of air is stopped. In step S33, the external load 12 is shifted to the external load stop mode. In the external load stop mode, the supply of air to the cathode channel 37 is reduced to lower the potential of the cathode, decreasing an average cell voltage (i.e., a state where a small amount of current flows into the external load 12). In step S34, the control unit 9 determines whether the average cell voltage is decreased to a predetermined voltage (20 mV, for example) or less. If the average cell voltage is a predetermined voltage or less (YES in step S34), the control unit 9 shifts the value of the external load 12 to zero (in step S35) and stops the supply of hydrogen (in step S36). After the control unit 9 stops the supply of hydrogen, the control unit 9 stops the operation of the auxiliary equipments (in step S37). After the operation of the auxiliary equipments is stopped, the entire system is stopped (in step S38).

A method for starting the fuel cell system according to the present embodiment is described below.

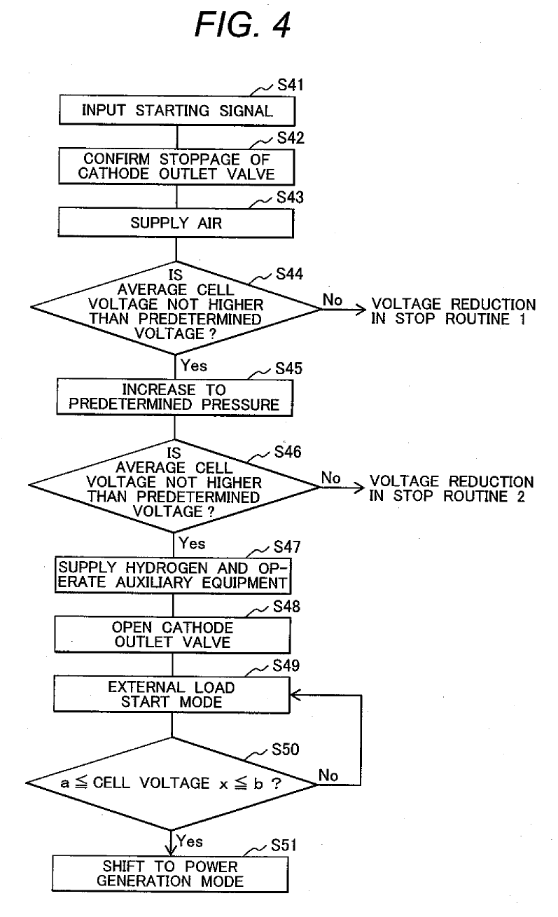

FIG. 4 is a flow chart showing a method for starting the fuel cell system.

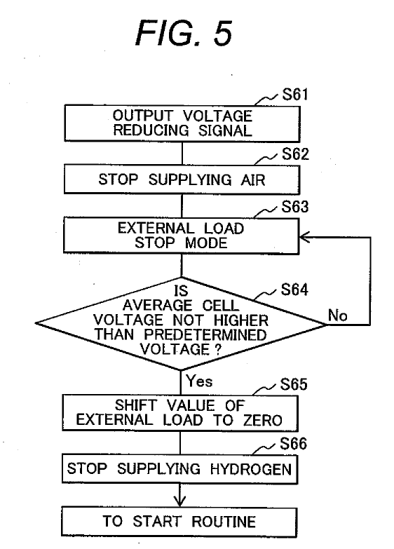

As shown in FIG. 4, in step S41, a starting signal is input. In step S42, the control unit 9 confirms the stoppage of the air outlet valve 7. After the control unit 9 confirms the stoppage of the air outlet valve 7, the control unit 9 causes the air blower 21 to supply air to the fuel cell 1 (in step S43). In step S44, the control unit 9 determines whether the cell voltage is not greater than a predetermined threshold voltage (taken as a first threshold voltage) using the cell voltage sensor 13. If the cell voltage is greater than the first threshold voltage (NO in step S44), the processing proceeds to a first voltage reduction routine and resumes the start of the fuel cell system in step S41 through the first voltage reduction routine. The first voltage reduction routine is described later in FIG. 5.

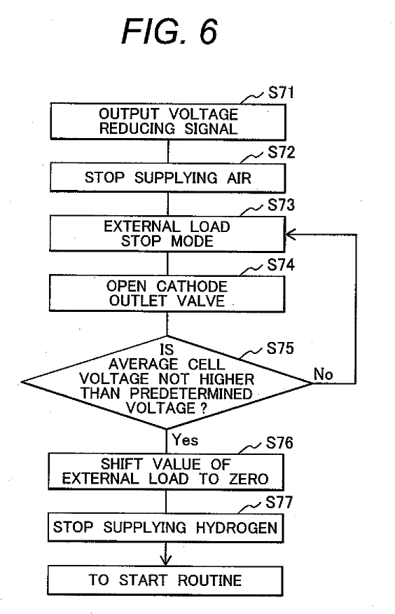

If the cell voltage is not greater than the first threshold voltage (YES in step S44), in step S45, pressure in the cathode channel 37 is increased to a predetermined pressure by the cathode pressure regulation valve 4. When pressure in the cathode channel 37 is increased to the predetermined pressure, in step S46, the control unit 9 determines whether the average cell voltage is not greater than a predetermined threshold voltage (taken as a second threshold voltage). If the average cell voltage is greater than the predetermined threshold voltage (NO in step S46), the processing proceeds to a second voltage reduction routine and resumes the start of the fuel cell system in step S41 through the second voltage reduction routine. The second voltage reduction routine is described later in FIG. 6. The first and the second threshold voltages at which shift to the first or the second voltage reduction routine is determined are 20 mV. The threshold voltages are properly determined according to output characteristics of the fuel cell 1.

When pressure in the cathode channel 37 is increased to the predetermined pressure, if the average cell voltage is not greater than the second threshold voltage (YES in step S46), in step S47, the control unit 9 operates the auxiliary equipment on the anode side such as the hydrogen supply source 20, the anode pressure regulation valve 5, the anode circulation system 6, and the hydrogen outlet valve 8 to supply hydrogen to the fuel cell 1. Thereafter, in step S48, the air outlet valve 7 is opened automatically or by receiving an output fetch signal to eject air, continuously circulating air in the cathode channel 37. In step S49, the control unit 9 shifts the external load 12 to the start mode and controls the current value output from the fuel cell 1 so that the average cell voltage can be kept within a predetermined range between a [mV] or more (700 mV, for example) and b [mV] or less (800 mV, for example). The average cell voltage is taken as a [mV] or more to confirm that fuel gas and oxidizer gas are sufficiently supplied to the electrodes on the anode and the cathode side respectively. On the other hand, the average cell voltage is taken as b [mV] or less to prevent platinum in catalyst from melting at a high potential. In step S50, the control unit 9 determines whether the average cell voltage is within the above predetermined range. If the average cell voltage is within the predetermined range (YES in step S50), in step S51, the start of the fuel cell system is completed, and the processing proceeds to the power generation mode according to the request from the external load 12.

FIG. 5 is a flow chart showing the first voltage reduction routine.

As shown in FIG. 5, in the first voltage reduction routine, in step S61, a signal for reducing voltage is output. In step S62, the supply of air is stopped. In step S63, the external load 12 is shifted to the stop mode. Thereafter, in step S64, the control unit 9 determines whether the average cell voltage is not greater than the first threshold voltage (20 mV, for example). If the average cell voltage is not greater than the first threshold voltage (YES in step S64), in step S65, the control unit 9 shifts the value of the external load 12 to zero. In step S66, the supply of hydrogen is stopped. In this state, the fuel cell system can be shifted again to the start routine (step S41 in FIG. 4).

FIG. 6 is a flow chart showing the second voltage reduction routine.

As shown in FIG. 6, in the second voltage reduction routine, in step S71, a signal for reducing voltage is output. In step 572, the supply of air is stopped. In step S73, the external load 12 is shifted to the stop mode. Thereafter, in step S74, the air outlet valve 7 is slowly opened to discharge air. In step S75, the control unit 9 determines whether the average cell voltage is not greater than the second threshold voltage (20 mV, for example). If the average cell voltage is not greater than the second threshold voltage (YES in step S75), in step S76, the control unit 9 shifts the value of the external load 12 to zero. In step S77, the supply of hydrogen is stopped. In this state, the fuel cell system can be shifted again to the start routine (step S41 in FIG. 4). In other words, the first or the second voltage reduction routine is selected according to a state where the pressure of air is increased in starting the fuel cell system. The second voltage reduction routine is different from the first voltage reduction routine in that air with which the cathode channel 37 is filled is slowly discharged because the pressure of air is increased in the cathode channel 37 and then the supply of hydrogen is stopped.

The action of the present embodiment is described below.

The fuel cell system is stopped or the average cell voltage is reduced in the method described in FIG. 3 to cause reaction product water to adhere to the catalyst of the cathode, covering the surface of the catalyst. In this state, since the catalyst is not directly in contact with air, even if the cathode channel 37 is in an atmosphere of air or air is supplied to the cathode channel 37 at a low flow rate, the cathode potential is not increased. However, if air is supplied at a high flow rate, the supplied air blows off the reaction product water covering the catalyst of the cathode or the reaction product water is evaporated depending on conditions, so that the surface of the catalyst is exposed to increase the cathode potential. Air is supplied as usual to the cell to cause the reaction product water to disappear from the upstream of the cathode channel in the cell, thus making a difference in potential between the upstream and the downstream of the channel of the cathode electrode to form a local cell.

However, even if air is supplied to the cathode channel 37 at a low flow rate with the air outlet valve 7 closed to increase the pressure therein, the cathode potential can be caused to remain lowered. In the present exemplary embodiment, the air outlet valve 7 is opened with the pressure in the cathode channel 37 increased to discharge the air with which the cathode channel 37 is filled outside the fuel cell at a burst, thereby enabling almost uniformly removing the reaction product water covering the catalyst of the cathode from the electrode surface.

In this state, since the catalyst is in contact with air almost at the same time on the cathode surface, the cathode potential can be increased substantially equally on the surface. For this reason, the local cell can be prevented from being formed even at the time of starting to allow minimizing the disappearance of the carbon carrier caused by the formation of the local cell.

More specifically, the fuel cell system of the present embodiment enables the cathode potential to be increased momentarily and uniformly by leading air filled in the cathode channel 37 continuously after filling the cathode channel 37 with the air, or by opening the air outlet valve 7 and discharging the filled air in the cathode channel 37 at a burst after filling the cathode channel 37 with air with the air outlet valve 7 closed to increase the pressure of the air, particularly. For this reason, the formation of the local cell on the cathode can be minimized to reduce the deterioration of the membrane electrode assembly (carbon carrier) 33.

The fuel cell system of the present embodiment can prevent platinum in the catalyst from dissolving at a high potential by drawing a load from the fuel cell and setting the maximum value of the average cell voltage to 800 mV or less after leading the air. Dissolving platinum causes re-precipitating platinum thereafter, coarsening the particle size thereof, reducing the surface area of the particle of platinum, and degrading the cell properties. In other words, the fuel cell system of the present embodiment can prevent the cell characteristics from being degraded.

According to the fuel cell system of the present embodiment, even if air pressure is lowered for some reason, it is possible to return quickly the air pressure to a predetermined value by controlling the amount of air supplied to the cathode channel 37 based on an information from the pressure sensors 10 and 11 and the voltage sensor 13 attached to the fuel cell 1 when the cathode channel 37 of the fuel cell 1 is filled with air whose pressure is not higher than a saturated vapor pressure through the air supply line 15. This also eliminates a risk of breaking down gas seal configuration of the cell caused when the air pressure is increased.

If the average cell voltage is increased while the fuel cell system is being started, the local cell may be formed.

However, it is possible to lower the voltage speedily and to start the system again by shifting the fuel cell system to the first and the second voltage reduction routine described in FIGS. 5 and 6.

An example of the present invention is described with reference to a comparative example.

### EXAMPLE OF THE PRESENT INVENTION

In the fuel cell system described in FIGS. 1 to 6, the range of the decrease in the average cell voltage caused by repeating starting and stopping the fuel cell system was measured. Specifically, an initial average cell voltage was first confirmed at a current density of 0.5 A/cm² and then the stop and the start mode were repetitively executed 5000 times, thereafter a load of a current density of 0.5 A/cm² was applied to measure the average cell voltage. The range of the decrease in the average cell voltage from the initial average cell voltage obtained after the stop and the start were repeated 5000 times was 2 mV.

### Comparative Example

FIG. 7 is a block diagram showing a configuration of a comparative example of a fuel cell system.

As shown in FIG. 7, the fuel cell system of the comparative example is basically similar in configuration to the fuel cell system in FIG. 1, but different from the fuel cell system in FIG. 1 in that the cathode pressure regulation valve 4 and the cathode pressure sensor 11 are not provided on the air supply line 15.

A method for stopping the fuel cell system of the comparative example is similar to that described in FIG. 3.

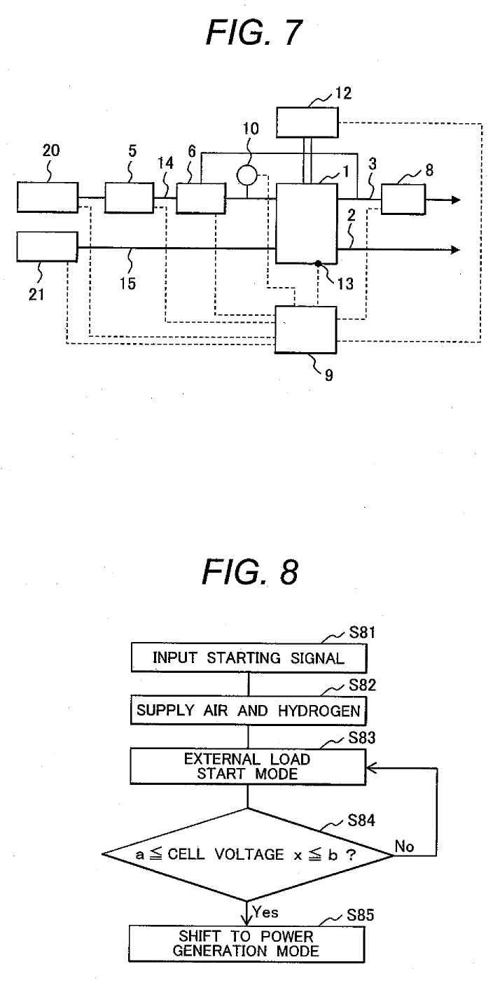

FIG. 8 is a flow chart showing a method for starting the fuel cell system of the comparative example.

As shown in FIG. 8, in step S81, a starting signal is input. In step S82, the air blower 21 supplies air to the fuel cell 1 and the hydrogen supply source 20 supplies hydrogen to the fuel cell 1. In step S83, the external load 12 shifted to the external load start mode is connected to the fuel cell system. In step S84, the control unit 9 determines whether the average cell voltage is within the predetermined range. If the average cell voltage is within the predetermined range (YES in step S84), in step S85, the external load start mode is completed and the processing proceeds to the power generation mode.

As is the case with the above example of the present invention, the comparative example was measured. Specifically, an initial average cell voltage was first confirmed at a current density of 0.5 A/cm² and then the stop and the start mode were repetitively executed 5000 times, thereafter a load of a current density of 0.5 A/cm² was applied to measure the average cell voltage. As a result, the range of the decrease in the average cell voltage from the initial average cell voltage obtained after the stop and the start were repeated 5000 times was 80 mV.

The reason why the range of the decrease in the average cell voltage of the example of the present invention is smaller than that of the comparative example is that the cell voltage is lowered by the corrosion of the carbon carrier caused by the reaction of local cell of the cathode at the time of starting in the comparative example, on the other hand, deterioration of the carbon carrier hardly occurs in the example of the present invention since the distribution of voltage on the cathode surface is made substantially uniform at the time of starting not to form a local cell.

According to the fuel cell system of the present embodiment, the method for starting the fuel cell system whereby to minimize the reaction of the local cell of the cathode is used to substantially reduce degradation in performance of the fuel cell system even if the start and stop of the system are frequently repeated.

The present invention is applicable to not only the above embodiments but other various examples.

What is claimed is:

1. A fuel cell system comprising:
a fuel cell;
a hydrogen supply unit for supplying hydrogen to an anode channel of the fuel cell;
an air-amount adjusting unit for adjusting the amount of air supplied to a cathode channel of the fuel cell and discharged from the cathode channel;
an external load connected to the fuel cell; and
a control unit for controlling an operation of the hydrogen supply unit, the air-amount adjusting unit and the external load,
wherein the control unit controls the fuel cell system such that the cathode channel of the fuel cell is filled with air whose pressure is not higher than a saturated vapor pressure at the time of starting the fuel cell system, thereafter, the air is continuously led through the cathode channel of the fuel cell, and a load is drawn from the fuel cell.

2. The fuel cell system according to claim 1,
wherein the air-amount adjusting unit includes an air supply line for supplying air to the cathode channel of the fuel cell, a cathode pressure regulation valve and an air pressure sensor provided on the air supply line, an air discharge line for discharging air from the cathode channel of the fuel cell, and an air outlet valve provided on the air discharge line, and
the control unit controls the fuel cell system such that the cathode channel of the fuel cell is filled with air whose pressure is not higher than the saturated vapor pressure through the air supply line with the air outlet valve closed to make a pressure in the cathode channel higher than a pressure in the cathode channel at the time of power generation.

3. The fuel cell system according to claim 2,
wherein the control unit controls the fuel cell system such that the air outlet valve is opened to discharge at a burst the air with which the cathode channel is filled when the cathode channel of the fuel cell is filled with air whose pressure is not higher than the saturated vapor pressure through the air supply line to continuously lead the air through the cathode channel.

4. The fuel cell system according to claim 3,
wherein a load is drawn from the fuel cell after the air is led through the cathode channel, thereby the maximum value of an output voltage per unit fuel cell is set to 800 mV or less.

5. The fuel cell system according to claim 2, further comprising a voltage sensor for measuring the output voltage of the fuel cell,
wherein the amount of air supplied to the cathode channel is controlled based on an information from the air pressure sensor and the voltage sensor which are attached to the fuel cell when the cathode channel is filled with air whose pressure is not higher than the saturated vapor pressure.

6. The fuel cell system according to claim 5,
wherein the supply of air is stopped and an output voltage per unit fuel cell is reduced if the output voltage is higher than a first predetermined threshold voltage after the supply of air is started with the air outlet valve closed; on the other hand, the supply of air is stopped and the air outlet valve is opened to lower the output voltage if the output voltage is not higher than the first threshold voltage and the output voltage is higher than a second predetermined threshold voltage after the pressure of air with which the cathode channel is filled is increased, when the cathode channel is filled with air whose pressure is not higher than the saturated vapor pressure.
